(19) United States
(12) Patent Application Publication
(10) Pub. No.: US 2026/0088459 A1
(43) Pub. Date: Mar. 26, 2026

(54) BATTERY ELECTRODE WITH NON-UNIFORM TAB

(71) Applicant: Apple Inc., Cupertino, CA (US)

(72) Inventors: Hirotsugu Oba, Sunnyvale, CA (US); Angus S. Smith, San Jose, CA (US); Nathan L. Creado, San Francisco, CA (US); David T. Wong, Redwood City, CA (US); Zhengyuan Tu, Santa Clara, CA (US); Sangwon Shin, Santa Clara, CA (US)

(21) Appl. No.: 18/895,102

(22) Filed: Sep. 24, 2024

(51) Int. Cl. H01M 50/533; H01M 50/54

(52) U.S. Cl. CPC H01M 50/533; H01M 50/54

(57) ABSTRACT

An electrode includes a body and a tab extending from the body. The tab includes a first cross-sectional area at a first location along a length of the tab, a second cross-sectional area at a second location along the length of the tab, and a third cross-sectional area at a third location along the length of the tab, where the second location is between the first location and the third location. The second cross-sectional area is less than at least one of the first cross-sectional area or the third cross-sectional area.

### BACKGROUND

The present disclosure relates generally to a battery, such as a secondary or rechargeable battery (e.g., lithium-ion battery), and more specifically to at least one non-uniform tab of at least one electrode of the battery.

Certain batteries may include electrodes, such as anodes and cathodes, where each electrode includes a body and a tab extending from the body. For example, the body and the tab may form a current collector of the electrode. The tabs of one or more groups of the electrodes may be coupled to a corresponding terminal of the battery. For example, anode tabs of the anodes may be coupled to a first terminal of the battery, and cathode tabs of the cathodes may be coupled to a second terminal of the battery. In some embodiments, an enclosure of the battery (e.g., in which the anodes, the cathodes, one or more separators, electrolyte, and other parts are disposed), such as a can, may operate as one of the two terminals.

In certain batteries, the anode tabs of the anodes may be bent between anode bodies of the anodes and the first terminal of the battery (e.g., during assembly of the battery). Additionally or alternatively, cathode tabs of the cathodes may be bent between cathode bodies of the cathodes and the second terminal of the battery (e.g., during assembly of the battery). Unfortunately, traditional configurations may suffer from uncontrollable and/or unpredictable bends in at least some of the tabs of the electrodes. For example, a first anode tab of a first anode may bend at an undesirable angle and/or location during assembly of the battery, causing a first anode body of the first anode to separate (e.g., delaminate) from an adjacent second anode body of an adjacent second anode. Additionally or alternatively, a first cathode tab of a first cathode may bend at an undesirable angle and/or location during assembly of the battery, causing a first cathode body of the first cathode to separate (e.g., delaminate) from an adjacent second cathode body of an adjacent second cathode. Bending of the tabs at undesirable angles and/or undesirable locations can cause a variety of negative effects, such as degraded performance of the battery, degraded longevity of the battery, degraded volumetric energy density of the battery, and/or increased likelihood of shorting. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an electrode includes a body and a tab extending from the body. The tab includes a first cross-sectional area at a first location along a length of the tab, a second cross-sectional area at a second location along the length of the tab, and a third cross-sectional area at a third location along the length of the tab, where the second location is between the first location and the third location. The second cross-sectional area is less than at least one of the first cross-sectional area or the third cross-sectional area

In another embodiment, an electrode assembly includes an electrode having a body and a tab extending from the body. The tab includes a first tab cross-sectional area at a first tab location along a length of the tab, a second tab cross-sectional area at a second tab location along the length of the tab, and a third tab cross-sectional area at a third tab location along the length of the tab, where the second tab location is between the first tab location and the third tab location. The second tab cross-sectional area is less than at least one of the first tab cross-sectional area or the third tab cross-sectional area. The electrode assembly also includes an additional electrode having an additional body and an additional tab extending from the additional body. The additional tab includes a first additional tab cross-sectional area at a first additional tab location along an additional length of the additional tab, a second additional tab cross-sectional area at a second additional tab location along the additional length of the additional tab, and a third additional tab cross-sectional area at a third additional tab location along the additional length of the additional tab, where the second additional tab location is between the first additional tab location and the third additional tab location. The second additional tab cross-sectional area is less than at least one of the first additional tab cross-sectional area or the third additional tab cross-sectional area. The electrode assembly also includes a plurality of electrodes disposed between the electrode and the additional electrode.

In another embodiment, an electrode assembly includes a first electrode having a first body and a first tab extending from the first body. The first tab includes a first cross-sectional area at a first location along a length of the first tab, a second cross-sectional area at a second location along the length of the first tab, and a third cross-sectional area at a third location along the length of the first tab, where the second location is between the first location and the third location. The second cross-sectional area is less than at least one of the first cross-sectional area or the third cross-sectional area. The electrode assembly also includes a second electrode having a second body and a second tab. The second tab includes a proximal end coupled to the second body, a distal end opposing the proximal end, a first substantially straight edge extending from the proximal end to the distal end, and a second substantially straight edge extending from the proximal end to the distal end. The second substantially straight edge opposes the first substantially straight edge across a width of the second tab.

In another embodiment, an electrode includes a body and a tab extending from the body. The tab includes a first stiffness at a first location along a length of the tab based on a first tab characteristic at the first location, a second stiffness at a second location along the length of the tab based on a second tab characteristic at the second location, and a third stiffness at a third location along the length of the tab based on a third tab characteristic at the third location. The second location is between the first location and the third location, and the second stiffness is different than at least one of the first stiffness or the third stiffness based on the second tab characteristic differing from at least one of the first tab characteristic or the third tab characteristic.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery configured to power a load, such as the electronic device of FIG. 1, including an electrode assembly, where the electrode assembly includes a first electrode with a first tab having a non-uniform cross-sectional area along a first length thereof, and where the electrode assembly includes a second electrode with a second tab having a substantially uniform cross-sectional area along a second length thereof, according to embodiments of the present disclosure;

FIG. 3 is a perspective view of an electrode assembly for use in a battery, such as the battery of FIG. 2, including a plurality of anodes and a plurality of cathodes, according to embodiments of the present disclosure;

FIG. 4 is a top-down view of the electrode assembly of FIG. 3, according to embodiments of the present disclosure;

FIG. 5 is a top-down view of an electrode assembly for use in a battery, such as the battery of FIG. 2, including an anode and a cathode, according to embodiments of the present disclosure;

FIG. 6 is a top-down view an electrode assembly for use in a battery, such as the battery of FIG. 2, including a first anode and a second anode, according to embodiments of the present disclosure;

FIG. 7 is a top-down view of an electrode assembly for use in a battery, such as the battery of FIG. 2, including a first cathode and a second cathode, according to embodiments of the present disclosure;

FIG. 8 is top-down view of an electrode of an electrode assembly for use in a battery, such as the battery of FIG. 2, according to embodiments of the present disclosure;

FIG. 9 is a side view of an electrode of an electrode assembly for use in a battery, such as the battery of FIG. 2, according to embodiments of the present disclosure;

FIG. 10 is a side cross-sectional view of a portion of a battery, according to embodiments of the present disclosure; and

FIG. 11 is a process flow diagram illustrating a method of manufacturing a battery, such as the battery of FIG. 2, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to a battery, such as a secondary or rechargeable battery (e.g., lithium-ion battery). More specifically, the present disclosure is directed to at least one non-uniform tab of at least one electrode of the battery, as described in greater detail below.

In accordance with the present disclosure, a battery may include, among other features, electrodes (e.g., at least one anode and at least one cathode), a separator, an electrolyte, and an enclosure (e.g., a can or a pouch) in which the electrodes, separator, and electrolyte are disposed. Each electrode includes a body and a tab extending from the body. Certain tabs of certain electrodes include non-uniform geometry, such as a reduced cross-sectional area at a particular location along a length of the tab. The reduced cross-sectional area at the particular location along the length of the tab, for example, promotes a controlled and/or predictable bending at the particular location (e.g., as opposed to another location) during assembly of the battery, which reduces a likelihood that the body of the electrode separates (e.g., delaminates) from an adjacent body of an adjacent electrode of the battery. Other example non-uniform tab characteristics in accordance with the present disclosure may include varying degrees of porosity (e.g., pore density) along the length of the tab, the inclusion of perforations at one or more locations along the length of the tab, etc. In general, the varying characteristics along the length of the tab are configured to introduce varying stiffnesses along the length of the tab.

In some embodiments, only certain electrodes of the battery include the above-described (or some other type of) non-uniform tab. For example, electrodes at a top and/or bottom of an electrode assembly, also referred to as an electrode stock, may include the non-uniform tab. In other embodiments, all electrodes of the battery include the above-described (or some other type of) non-uniform tab. Additionally or alternatively, non-uniform tabs may be employed in anodes of the battery, cathodes of the battery, or both.

Features of the battery described above and in greater detail below enable more controllable and/or more predictable bending, relative to traditional configurations, of the tab of at least one electrode of the battery (e.g., between the respective body of the at least one electrode and the terminal of the battery, and during assembly of the battery). The more controllable and/or more predictable bending of the tabs may improve battery performance, longevity, energy density, and/or other technical effects over traditional configurations. Additionally or alternatively, the more controllable and/or more predictable bending of the tabs may reduce a likelihood of shorting relative to traditional configurations. These and other aspects of the present disclosure are described in detail below with reference to the drawings.

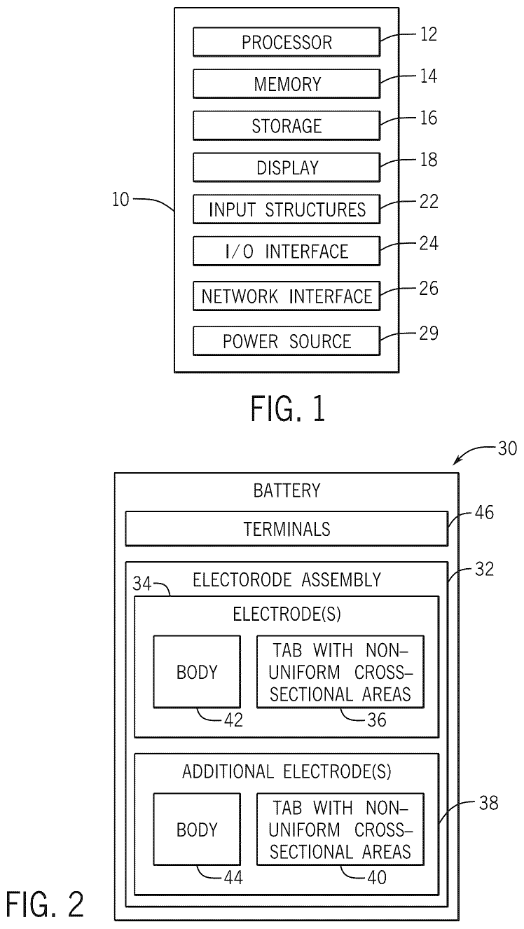

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The power source 29 of the electronic device 10 may include any suitable source of power, such as a rechargeable lithium polymer battery (e.g., lithium-ion battery) and/or an alternating current (AC) power converter. In accordance with the present disclosure, the battery of the power source 29 may include at least one electrode having a body, a tab extending from the body, and a non-uniform cross-sectional area of the tab along a length of the tab. As an example, the tab may include a first cross-sectional area at a first location along the length of the tab, a second cross-sectional area at a second location along the length of the tab, and a third cross-sectional area at a third location along the length of the tab, where the second location is between the first location and the third location. The second cross-sectional area may be, for example, different than (e.g., less than) the first cross-sectional area, the third cross-sectional area, or both. The second cross-sectional area being less than the first cross-sectional area and the third cross-sectional area may promote a desirable bending of the tab at the second location during assembly of the battery (e.g., during a coupling between the tab of the electrode and a terminal of the battery). The desirable bending of the tab at the second location (e.g., as opposed to the first location and/or the third location) may reduce or negate a likelihood that the electrode separates (e.g., delaminates) from an adjacent second electrode of the battery. In other embodiments, the second cross-sectional area may be greater than at least one of the first cross-sectional area or the third cross-sectional area. These and other aspects of the present disclosure are described in detail below with reference to the drawings.

FIG. 2 is a block diagram of an embodiment of a battery 30 configured to power a load, such as the electronic device 10 of FIG. 1, including an electrode assembly 32, where the electrode assembly 32 includes a first electrode 34 with a first tab 36 having a non-uniform cross-sectional area along a first length thereof, and where the electrode assembly 32 includes a second electrode 38 with a second tab 40 having a substantially uniform cross-sectional area along a second length thereof. For example, the first tab 36 of the first electrode 34 extends from a first body 42 of the first electrode 34. The first tab 36 and the first body 42 may form a first current collector of the first electrode 34. In some embodiments, first active material (not shown) may be disposed on the first body 42 of the first electrode 34. Likewise, the second tab 40 of the second electrode 38 extends from a second body 44 of the second electrode 38. The second tab 40 and the second body 44 may form a second current collector of the second electrode 38. In some embodiments, second active material (not shown) may be disposed on the second body 44 of the second electrode 38. The first tab 36 and the second tab 40 may be coupled to terminals 46 (e.g., the same terminal or different terminals) of the battery 30.

As described in greater detail with reference to later drawings, the first tab 36 of the first electrode 34 may include various characteristics that introduce varying levels of stiffness at various locations along a length of the first tab 36. For example, the first tab 36 may include a first stiffness at a first location along the length of the first tab 36 (e.g., based on one or more first tab characteristics at the first location), a second stiffness at a second location along the length of the first tab 36 (e.g., based on one or more second tab characteristics at the second location), and a third stiffness at a third location along the length of the first tab 36 (e.g., based on one or more third tab characteristics at the third location), where the second location is between the first location and the third location, and the second stiffness is different than (e.g., less than) at least one of the first stiffness or the third stiffness. The varying stiffnesses may be based on varying tab characteristics along the length of the first tab 36, such as varying cross-sectional area, cross-sectional width, cross-sectional thickness, porosity (e.g., pore density), perforations (e.g., a presence of perforations at the second location and a lack of perforations in at the first location and the third location), density, and the like.

In one embodiment, the first tab 36 includes a non-uniform cross-sectional area along a length of the first tab 36. For example, the first tab 36 may include a first cross-sectional area at a first location along the length of the first tab 36, a second cross-sectional area at a second location along the length of the first tab 36, and a third cross-sectional area at a third location along the length of the first tab 36, where the second location is between the first location and the third location, and the second cross-sectional area is different than (e.g., less than) at least one of the first cross-sectional area and the third cross-sectional area, such as less than each of the first cross-sectional area and the third cross-sectional area. The second cross-sectional area may be less than the first cross-sectional area and the third cross-sectional area by way of a reduction in a thickness and/or a reduction in a width of the first tab 36 at the second location (e.g., where the thickness extends transverse or perpendicular to the length, the width extends transverse or perpendicular to the length, and the thickness extends transverse or perpendicular to the width). In some embodiments, the second cross-sectional area may be greater than at least one of the first cross-sectional area or the third cross-sectional area.

As previously described, the first tab 36 may be coupled to one of the terminals 46 of the battery 30. In some embodiments, the first tab 36 of the first electrode 34 is bent between the first body 42 of the first electrode and the terminal 46 (or an intervening component) to which the first tab 36 is coupled. The reduced thickness and/or reduced width of the first tab 36 at the second location, which causes the second cross-sectional area to be less than each of the first cross-sectional area and the third cross-sectional area, promotes the bending of the first tab 36 at the second location. In this way, the bending of the first tab 36 is more controllable and/or predictable, thereby reducing a likelihood of bending at an undesirable location and/or angle of the first tab 36, which may otherwise cause the first body 42 of the first electrode 34 to separate (e.g., delaminate) from an adjacent electrode of the battery 30, such as the second electrode 38.

In some embodiments, certain electrodes of the battery 30 include a tab with a uniform cross-sectional area. For example, the second tab 40 of the second electrode 38 in FIG. 2 includes a uniform cross-sectional area (e.g., the second tab 40 includes a generally rectangular shape from a proximal end of the second tab 40 coupled to the second body 44 and a distal end opposing the proximal end). Indeed, certain electrodes of the battery 30 may be less susceptible or prone to undesirable bending locations and/or angles of respective electrode tabs. As an example, in certain embodiments, many electrodes of the battery 30 are disposed in a stack (e.g., in an anode/cathode alternating configuration, with one or more separators disposed between each adjacent anode and cathode), where a first outer (e.g., upper) electrode of the stack and a second outer (e.g., lower) electrode of the stack are more prone to separation (e.g., delamination) from the stack due to undesirable bending locations and/or angles of the respective electrode tabs than inner (e.g., middle, mid-section) electrodes of the stack. In such an embodiment, the first outer (e.g., upper) electrode of the stack and the second outer (e.g., lower) electrode of the stack may correspond to or resemble characteristics of the first electrode(s) 34 in FIG. 1, whereas the inner (e.g., middle, mid-section) electrodes of the stack correspond to or resemble characteristics of the second electrode(s) 38 in FIG. 1. Other examples are also possible and described in greater detail below with reference to later drawings.

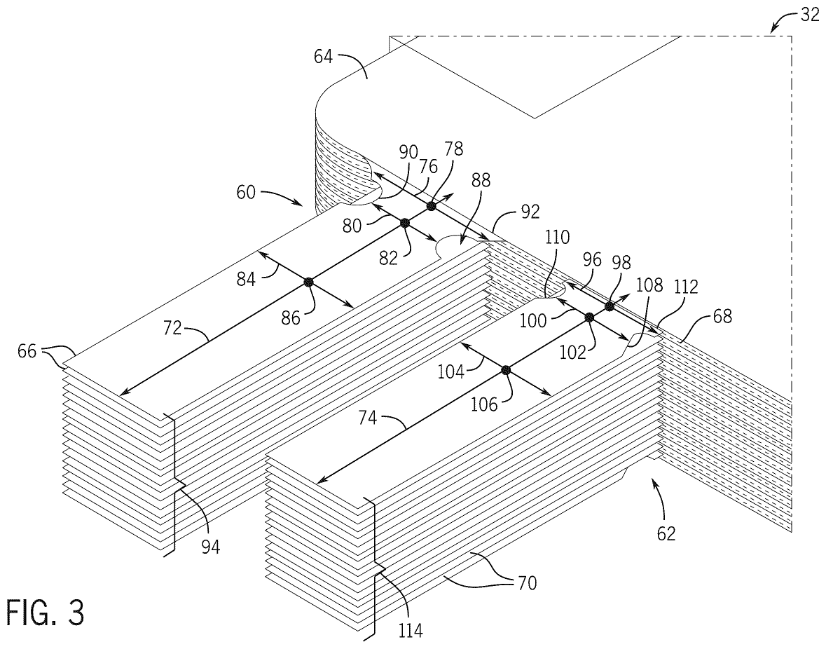

FIG. 3 is a perspective view of an embodiment of the electrode assembly 32 for use in a battery, such as the battery 30 of FIG. 2, including a plurality of anodes 60 and a plurality of cathodes 62 (collectively referred to as “electrodes”). Each anode 60 includes an anode body 64 and an anode tab 66 extending from the anode body 64. Further, each cathode 62 includes a cathode body 68 and a cathode tab 70 extending from the cathode body 68. The anodes 60 and the cathodes 62 are disposed in a stacked and alternating configuration. One or more separators may be disposed between adjacent instances of the anode 60 and adjacent instances of the cathode 62.

The anode tabs 66 each include an anode tab length 72 and the cathode tabs 70 each include a cathode tab length 74. As shown, an outer (e.g., upper) instance of the anode 60 includes a reduced cross-sectional area at a particular location along the anode tab length 72 of the anode tab 66. For example, the anode tab 66 of the outer (e.g., upper) instance of the anode 60 includes a first cross-sectional width 76 at a first location 78 along the anode tab length 72, a second cross-sectional width 80 at a second location 82 along the anode tab length 72, and a third cross-sectional width 84 at a third location 86 along the anode tab length 72, where the second location 82 is between the first location 78 and the third location 86, and the second cross-sectional width 80 is different than (e.g., less than) at least one of the first cross-sectional width 76 or the third cross-sectional width 84. In the illustrated embodiment, the second cross-sectional width 80 is less than each of the first cross-sectional width 76 and the third cross-sectional width 84. In some embodiments, the first cross-sectional width 76 is greater than or equal to the third cross-sectional width 84. As shown, a reduced size of the second cross-sectional width 80 (e.g., compared to each of that of the first cross-sectional width 76 and the third cross-sectional width 84) may be facilitated by first and second curvilinear edges 88, 90 (e.g., first and second semi-circles or half-circles) disposed on opposing sides or edges of the anode tab 66 of the outer (e.g., upper) instance of the anode 60, although other geometries are also possible. While the outer (e.g., upper) instance of the anode 60 may include the above-described tab geometries, and another outer (e.g., lower) instance of the anode 60 may include the above-described tab geometries, other (e.g., inner, middle, mid-section) instances of the anode 60 may not include the above-described tab geometries in certain embodiments. For example, the other (e.g., inner, middle, mid-section) instances of the anode 60 may include substantially rectangular tab geometries extending between proximal ends 92 of the anode tabs 66 of such anodes 60 and distal ends 94 of the anode tabs 66 of such anodes 60, where the proximal ends 92 couple to the anode bodies 64 and the distal ends 94 oppose the proximal ends 92.

Likewise, as shown, an outer (e.g., upper) instance of the cathode 62 includes a reduced cross-sectional area at a particular location along the cathode tab length 74 of the cathode tab 70. For example, the cathode tab 70 of the outer (e.g., upper) instance of the cathode 62 includes a first cross-sectional width 96 at a first location 98 along the cathode tab length 74, a second cross-sectional width 100 at a second location 102 along the cathode tab length 74, and a third cross-sectional width 104 at a third location 106 along the cathode tab length 74, where the second location 102 is between the first location 98 and the third location 106, and the second cross-sectional width 100 is different than (e.g., less than) at least one of the first cross-sectional width 96 or the third cross-sectional width 104. In the illustrated embodiment, the second cross-sectional width 100 is less than each of the first cross-sectional width 96 and the third cross-sectional width 104. In some embodiments, the first cross-sectional width 96 is greater than or equal to the third cross-sectional width 104. As shown, a reduced size of the second cross-sectional width 100 (e.g., compared to each of that of the first cross-sectional width 96 and the third cross-sectional width 104) may be facilitated at least in part by first and second tapered edges 108, 110 on opposing sides or edges of the cathode tab 70 of the outer (e.g., upper) instance of the cathode 62, although other geometries are also possible. While the outer (e.g., upper) instance of the cathode 62 may include the above-described tab geometries, and another outer (e.g., lower) instance of the cathode 62 may include the above-described tab geometries, other (e.g., inner, middle, mid-section) instances of the cathode 62 may not include the above-described tab geometries in certain embodiments. For example, the other (e.g., inner, middle, mid-section) instances of the cathode 62 may include substantially rectangular tab geometries extending between proximal ends 112 of the cathode tabs 70 of such cathodes 62 and distal ends 114 of the cathode tabs 70 of such cathodes 62, where the proximal ends 112 couple to the cathode bodies 68 and the distal ends 114 oppose the proximal ends 112.

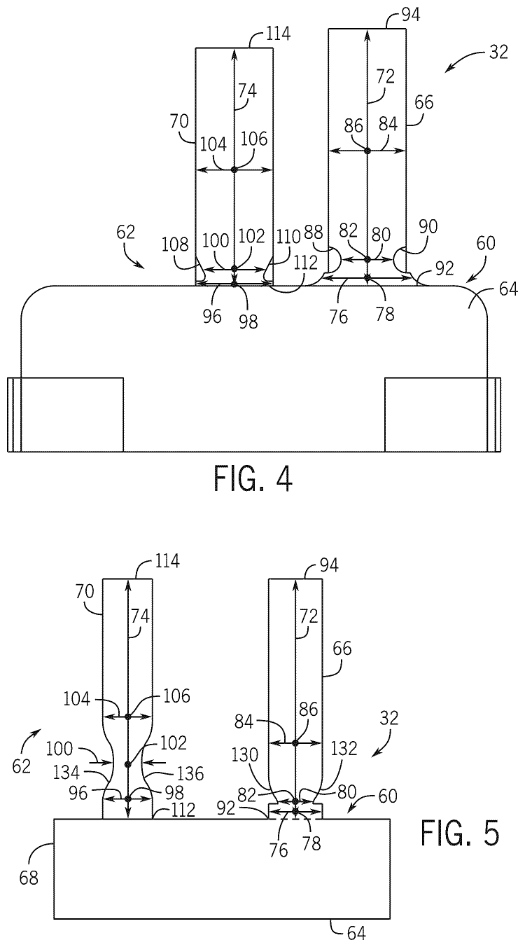

The above-described geometries of the anode tabs 66 and the cathode tabs 70, such as the geometries of the anode tabs 66 corresponding to the outer (e.g., upper and lower) instances of the anode 60 and the geometries of the cathode tabs 70 corresponding to the outer (e.g., upper and lower) instances of the cathode 62, may enable controlled tab bending at desirable tab locations and/or angles, as previously described. For example, the anode tab 66 of the outer (e.g., upper) instance of the anode 60 is configured to have a higher likelihood of bending at or adjacent to the second location 82 along the anode tab length 72, and the cathode tab 70 of the outer (e.g., upper) instance of the cathode 62 is configured to have a higher likelihood of bending at or adjacent to the second location 102 along the cathode tab length 74, as previously described. FIG. 4 is a top-down view of an embodiment of the electrode assembly 32 of FIG. 3, including the same or similar features described in detail above.

Other tab geometries besides those described above with respect to FIGS. 3 and 4 are also possible in accordance with the present disclosure. For example, FIG. 5 is a top-down view of an embodiment of the electrode assembly 32 for use in a battery, such as the battery 30 of FIG. 2, including at least one instance of the anode 60 and at least one instance of the cathode 62. The embodiment in FIG. 5 may include many of the same or similar features described above with respect to FIGS. 3 and 4. However, in FIG. 5, among other distinctions, the second cross-sectional width 80 of the anode tab 66 at the second location 82 along the anode tab length 72 is smaller than each of the first cross-sectional width 76 at the first location 78 along the anode tab length 72 and the third cross-sectional width 84 at the third location 86 along the anode tab length 72 by way of tapered edges 130, 132 on opposing sides or edges of the anode tab 66 (e.g., as opposed to the curvilinear, semi-circle, or half-circle features described above with respect to FIGS. 3 and 4). Further, the second cross-sectional width 100 of the cathode tab 70 at the second location 102 along the cathode tab length 74 is smaller than each of the first cross-sectional width 96 at the first location 98 along the cathode tab length 74 and the third cross-sectional width 104 at the third location 106 along the cathode tab length 74 by way of curvilinear edges 134, 136 on opposing sides or edges of the cathode tab 70 (e.g., as opposed to the tapered features described above with respect to FIGS. 3 and 4).

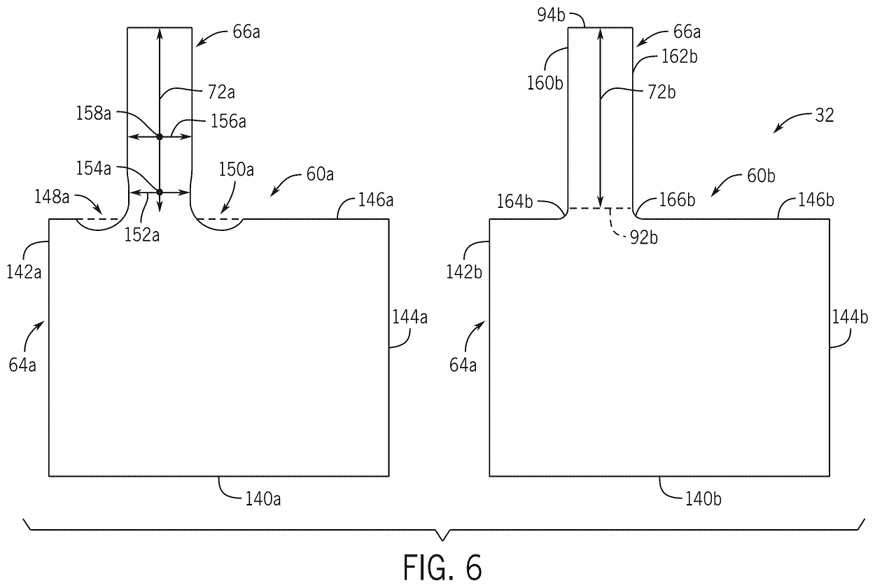

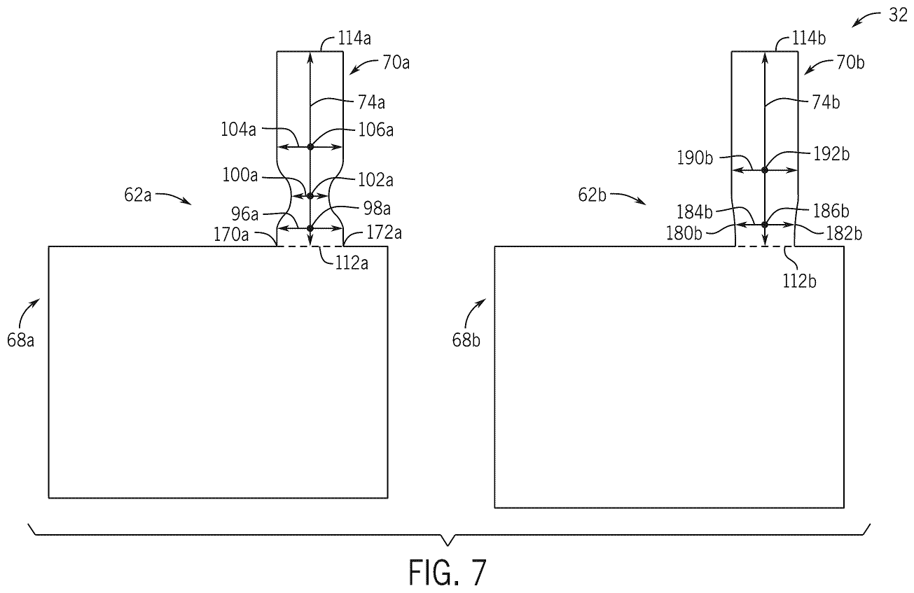

Still other electrode (e.g., tab, body) geometries besides those described above with respect to FIGS. 3-5 are also possible in accordance with the present disclosure. For example, FIG. 6 is a top-down view the electrode assembly 32 for use in a battery, such as the battery 30 of FIG. 2, including a first anode 60a and a second anode 60b, and FIG. 7 is a top-down view of an embodiment of the electrode assembly 32 for use in a battery, such as the battery 30 of FIG. 2, including a first cathode 62a and a second cathode 62b. Focusing first on FIG. 6, the first anode 60a may represent, in certain embodiments, one or more outer anodes (e.g., an upper anode and a lower anode) of an electrode stack corresponding to the electrode assembly 32, whereas the second anode 60b may represent, in certain embodiments, one or more inner anodes (e.g., middle or mid-section anodes) of the electrode stack corresponding to the electrode assembly 32. While the first anode 60a and the second anode 60b are offset in the illustrated embodiment to clearly illustrate their features, it should be understood that at least one instance of the first anode 60a and at least one instance of the second anode 60b may be stacked in the electrode stack of the electrode assembly 32 as previously described.

As shown, the first anode 60a includes a first anode body 64a and a first anode tab 66a extending from the first anode body 64a. The first anode body 64a of the first anode 60a includes a first substantially straight edge 140a (e.g., bottom edge), a second substantially straight edge 142a (e.g., side edge), and a third substantially straight edge 144a (e.g., additional side edge). Likewise, the second anode body 64b of the second anode 60b includes a first substantially straight edge 140b (e.g., bottom edge), a second substantially straight edge 142b (e.g., side edge), and a third substantially straight edge 144b (e.g., additional side edge). In the first anode body 64a of the first anode 60a, a fourth edge 146a (e.g., upper edge) includes a first groove 148a and a second groove 150b extending toward the first substantially straight edge 140a, whereas in the second anode body 64b of the second anode 60b, a fourth edge 146b (e.g., upper edge) of the second anode body 64b does not include the same or similar grooves 148a, 150a of the first anode body 64a of the first anode 60a.

Further, while the first anode tab 66a of the first anode 60a includes a cross-sectional width 152a at a location 154a along the length 72a of the first anode tab 66a that is different than (e.g., less than) an additional cross-sectional width 156a at an additional location 158a along the length 72a of the first anode tab 66a, the second anode tab 66b of the second anode 60b includes different features. For example, the second anode tab 66b of the second anode 60b includes a first substantially straight edge 160b and a second substantially straight edge 162b, where the first substantially straight edge 160b and the second substantially straight edge 162b extend between a proximal end 92b of the second anode tab 66b coupled to the second anode body 64b of the second anode tab 66b and a distal end 94b opposing the proximal end 92b. In this way, the proximal end 92b, the distal end 94b, the first substantially straight edge 160b and the second substantially straight edge 162b may form a rectangular shape and/or a shape resembling a rectangle in certain embodiments. In some embodiments, a first fillet edge 164b extends between the first substantially straight edge 160b and the fourth edge 146b, and a second fillet edge 166b extends between the second substantially straight edge 162b and the fourth edge 156b, as shown.

Focusing now on FIG. 7, the first cathode 62a may represent, in certain embodiments, one or more outer cathodes (e.g., an upper cathode and a lower cathode) of an electrode stack corresponding to the electrode assembly 32, whereas the second cathode 62b may represent, in certain embodiments, one or more inner cathodes (e.g., middle or mid-section cathodes) of the electrode stack corresponding to the electrode assembly 32. In other embodiments, the second cathode 62b may also correspond to an outer cathode (e.g., an upper cathode or a lower cathode) of an electrode stack. While the first cathode 62a and the second cathode 62b are offset in the illustrated embodiment to clearly illustrate their features, it should be understood that at least one instance of the first cathode 62a and at least one instance of the second cathode 62b may be stacked in the electrode stack of the electrode assembly 32 as previously described. Alternatively, the first cathode 62a and the second cathode 62b may be in different electrode stacks of different instances of the electrode assembly 32 (e.g., in different embodiments).

As shown, the first cathode 62a in FIG. 7 may include the same or similar features as the cathode 62 illustrated in FIG. 5 and described in detail above. Accordingly, reference numerals illustrated with respect to the first cathode 62a in FIG. 7 are the same as the reference numerals illustrated with respect to the cathode 62 in FIG. 5, except that they each include an “a” suffix to denote that they are a part of the first cathode 62a of the electrode assembly 32 in FIG. 7. However, the first cathode 62a in FIG. 7 also includes first and second fillet edges 170a, 172a (hidden from view in FIG. 5) extending between opposing sides of the first cathode tab 70a and the first cathode body 68a of the first cathode 62a.

The second cathode 62b of the electrode assembly 32 in FIG. 7 includes a second cathode body 68b and a second cathode tab 70b extending from the second cathode body 68b. The second cathode tab 70b includes a first tapered edge 180b on a first side of the second cathode tab 70b and a second tapered edge 182b on a second side of the second cathode tab 70b. In this way, the second cathode tab 70b includes a cross-sectional width 184b at a location 186b along a second length 74b of the second cathode tab 70b (e.g., adjacent to a second proximal end 112b), and an additional cross-sectional width 190b at an additional location 192b along the second length 74b of the second cathode tab 70b (e.g., adjacent to a second distal end 114b), where the cross-sectional width 184b is different than (e.g., less than) the additional cross-sectional width 190b.

As previously described, reduced cross-sectional widths at particular locations of electrode tabs in FIGS. 6 and 7 may promote bending of the electrode tabs at the particular locations during assembly of the battery. While the embodiments described above include variable cross-sectional widths of certain anode tabs and/or cathode tabs, in certain embodiments of the present disclosure, the anode tabs and/or cathode tabs may include other electrode tab features configured to enable similar technical benefits, such as one or more perforated segments, differential density or porosity (e.g., pore density) between electrode tab segments, variable cross-sectional electrode tab thickness, etc.

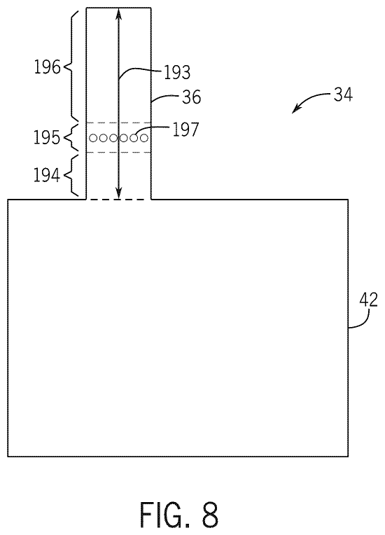

For example, FIG. 8 is top-down view of an embodiment of an electrode of an electrode assembly for use in a battery, such as the first electrode 34 of the electrode assembly 32 in the battery 30 of FIG. 2. It should be noted that the electrode 34 in the illustrated embodiment may be an anode or a cathode. That is, the features of the electrode 34 in the illustrated embodiment may be applicable to an anode, a cathode, or both.

As shown in FIG. 8, the electrode 34 includes the tab 36 and the body 42 from which the tab 36 extends. The tab 36 includes a tab length 193 extending from the body 42 of the electrode 42 and upwardly along the tab 36, as previously described. In accordance with the present disclosure, the tab 36 may include a first region 194 along the tab length 193, a second region 195 along the tab length 193, and a third region 196 along the tab length 193. A second stiffness in the second region 195 may be different than (e.g., less than or greater than) a first stiffness in the first region 194 and a third stiffness in the third region 196. The variable stiffness between the second region 195 and at least one of the first region 194 or the third region 196 may be based on one or more variable characteristics in the second region 195 relative to the first region 194 and/or the third region 196, such as variable cross-sectional area, variable cross-sectional thickness, variable cross-sectional width, variable density, variable porosity (e.g., pore density), perforations being disposed in at least one region (e.g., the second region 195) and not in at least one other region (e.g., the first region 194 and/or the third region 196), etc.

In one embodiment, the first region 194, the second region 195, and the third region 196 may be configured such that the first region 194 and the third region 196 are stronger than the second region 195, thereby promoting a bending of the tab 36 at the second region 195. As an example, the second region 195 may include perforations 197 therein, whereas the first region 194 and the third region 196 do not include such perforations, thereby reducing a cross-sectional area of the tab 36 at the second region 195 relative to the first region 194 and the third region 196. Additionally or alternatively, the second region 195 may include a relative low density or a relatively high porosity (e.g., pore density) compared to the first region 194 and the third region 196 in certain embodiments. In some embodiments, perforations, density, porosity, and/or other tab characteristics along the tab length 193 of the tab 36 are functionally graded such that the first region 194 and the third region 196 are stiffer and/or stronger than the second region 195, promoting a bending of the tab 36 at the second region 195 during assembly of the corresponding battery. In general, in accordance with the present disclosure, the tab 36 may be configured with one or more stiffness modifiers (e.g., reduced cross-sectional width or thickness, differential porosity, differential density, perforations, etc.) to promote one or more bends of the tab 36 at one or more desirable locations along the tab length 193 of the tab 36 during assembly of the battery.

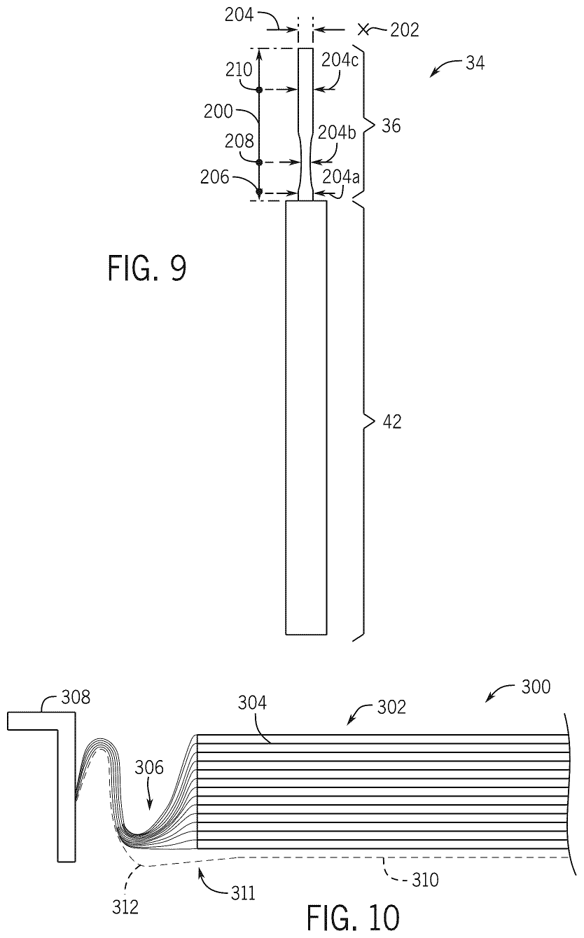

Further, FIG. 9 is a side view of an embodiment of an electrode of an electrode assembly for use in a battery, such as the first electrode 34 of the electrode assembly 32 in the battery 30 of FIG. 3. It should be noted that the electrode 34 in FIG. 9 may correspond to an anode or a cathode. While certain earlier embodiments illustrate an electrode tab with a reduced cross-sectional width at a particular location, the illustrated embodiment includes a reduced cross-sectional thickness at a particular location. For example, the electrode 34 includes the tab 36 and the body 42 from which the tab 36 extends. The tab 36 includes a tab length 200, a tab width 202 extending transverse to (e.g., perpendicular to) the tab length 200, and a tab thickness 204 extending transverse to (e.g., perpendicular to) the tab length 200 and the tab width 202. The tab length 200 may be greater than the tab width 202, and the tab width 202 may be greater than the tab thickness 204. In the illustrated embodiment, the tab thickness 204 may be variable along the tab length 200. For example, the tab 36 includes a first tab thickness 204a at a first location 206 along the tab length 200, a second tab thickness 204b at a second location 208 along the tab length 200, and a third tab thickness 204c at a third location 210 along the tab length 200, where the second location 208 is between the first location 206 and the third location 210, and the second tab thickness 204b is different than (e.g., less than) at least one of the first tab thickness 204a or the third tab thickness 204c. In the illustrated embodiment, the second tab thickness 204b is less than each of the first tab thickness 204a and the third tab thickness 204c. In this way, a cross-sectional area of the tab 36 at the second location 208 is less than a cross-sectional area of the tab 36 at the first location 206 and the third location 210, thereby promoting a bending of the tab 36 at the second location 208 during assembly of the battery.

While the illustrated embodiment includes a reduced thickness at a particular tab length location and earlier embodiments include a reduced width at a particular tab length location, it should be understood that certain embodiments of the present disclosure may include a reduced thickness and a reduced width at a particular tab length location. Further still, certain embodiments may include a reduced cross-sectional area (e.g., reduced thickness and/or reduced width) at multiple particular locations along the tab length to promote multiple bends at the multiple particular locations in accordance with the present disclosure.

FIG. 10 is a side view of an embodiment of a portion of a battery 300. The battery 300 includes an electrode assembly 302 having various electrodes 304 (e.g., anodes, cathodes, etc.). Although not denoted in the illustrated embodiment, one or more separators may be employed to separate adjacent electrodes, such as a cathode adjacent to an anode. As shown, electrode tabs 306 of at least some of the electrodes 304, such as anode tabs of the anodes, are coupled to a terminal 308 of the battery 300. In order to couple the electrode tabs 306 (e.g., anode tabs) to the terminal 308, the electrode tabs 306 may be bent in one or more locations. In accordance with the present disclosure, one or more of the electrode tabs 306 may include any one or more of the above-described features relating to non-uniform tab cross-sectional area. In this way, locations and/or angles of the bends in the electrode tab(s) 306 are controllable and predictable. In the absence of such feature, at least one electrode, such as an outer or bottom electrode 310, may at least partially separate (e.g., delaminate) from the other electrodes 304 (e.g., at a particular location 311) due to the corresponding electrode tab 312 bending at an undesirable location and/or at an undesirable angle. It should be noted that the bottom electrode 310 and the corresponding electrode tab 312 are illustrated in dashed line to denote a mere hypothetical undesirable tab bend location/angle and a mere hypothetical electrode separation (e.g., delamination), in order to clarify at least one problem solved by one or more of the presently disclosed features, which are included in the embodiment illustrated in FIG. 10.

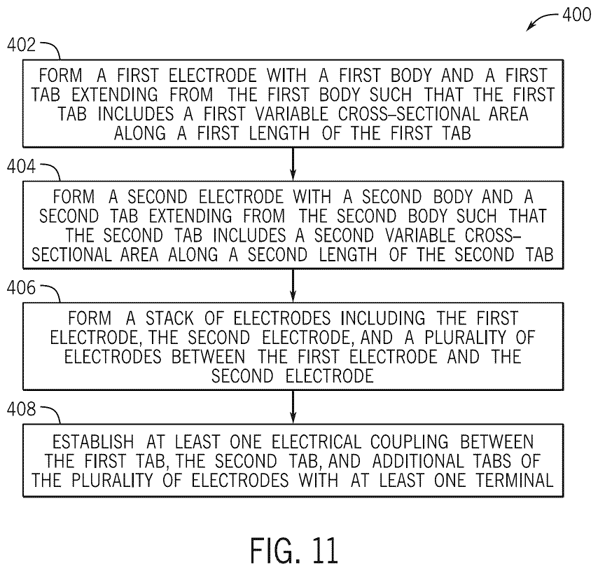

FIG. 11 is a process flow diagram illustrating an embodiment of a method 400 of manufacturing a battery, such as the battery 30 of FIG. 2. While the steps of the method 400 may be performed in the order illustrated in FIG. 11 and described below, it should be understood that other orders or chronologies are also possible. Further, it should be understood that additional steps not illustrated in FIG. 11 and/or described below may be employed in certain embodiments of the method 400, and certain steps illustrated in FIG. 11 and/or described below may be excluded in certain embodiments of the method 400.

In the illustrated embodiment, the method 400 includes forming (block 402) a first electrode with a first body and a first tab extending from the first body such that the first tab includes a first variable cross-sectional area (e.g., first variable cross-sectional width, first variable cross-sectional thickness, or both) along a first length of the first tab. For example, as previously described, the first tab may include a first cross-sectional area at a first location along the first length of the first tab, a second cross-sectional area at a second location along the first length of the first tab, and a third cross-sectional area at a third location along the first length of the first tab, where the second location is between the first location and the third location, and the second cross-sectional area is different than (e.g., less than) the first cross-sectional area and/or the third cross-sectional area. In this way, a bending of the first tab at the second location along the first length of the first tab is promoted during assembly of the battery. In some embodiments, the first electrode is an anode, while in other embodiments, the first electrode is a cathode.

The method 400 also includes forming (block 404) a second electrode with a second body and a second tab extending from the second body such that the second tab includes a second variable cross-sectional area (e.g., second variable cross-sectional width, second variable cross-sectional thickness, or both) along a second length of the second tab. For example, as previously described, the second tab may include a first additional cross-sectional area at a first additional location along the second length of the second tab, a second additional cross-sectional area at a second additional location along the second length of the second tab, and a third additional cross-sectional area at a third additional location along the second length of the second tab, where the second additional location is between the first additional location and the third additional location, and the second additional cross-sectional area is less than each of the first additional cross-sectional area and/or the third additional cross-sectional area. In this way, a bending of the second tab at the second additional location along the second length of the second tab is promoted during assembly of the battery. In some embodiments, the second electrode is an anode, while in other embodiments, the second electrode is a cathode.

The method 400 also includes forming (block 406) a stack of electrodes including the first electrode, the second electrode, and a plurality of electrodes between the first electrode and the second electrode. In some embodiments, some or all of the plurality of electrodes between the first electrode and the second electrode do not include tabs with variable cross-sectional areas. In other embodiments, some or all of the plurality of electrodes between the first electrode and the second electrode also include tabs with variable cross-sectional areas. The plurality of electrodes between the first electrode and the second electrode may include anodes, cathodes, or both.

The method 400 also includes establishing (block 408) at least one electrical coupling between the first tab, the second tab, and additional tabs of the plurality of electrodes with at least one terminal. For example, if the first electrode, the second electrode, and the plurality of electrodes are all anodes or all cathodes, then the first tab of the first electrode, the second tab of the second electrode, and the plurality of tabs of the plurality of electrodes may be coupled to a first terminal of the battery. If a first portion of the first electrode, the second electrode, and the plurality of electrodes are anodes and a second portion of the first electrode, the second electrode, and the plurality of electrodes are cathodes, the tabs of the first portion are coupled to the first terminal of the battery and the tabs of the second portion are coupled to a second terminal of the battery.

Technical benefits include more controllable and/or more predictable bending, relative to traditional configurations, of tabs of electrodes between bodies of the electrodes and a terminal of a battery. The more controllable and/or more predictable bending of the tabs improves battery performance, longevity, energy density, and/or other technical effects over traditional configurations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . , ” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electrode, comprising:
a body; and
a tab extending from the body, wherein the tab comprises a first cross-sectional area at a first location along a length of the tab, a second cross-sectional area at a second location along the length of the tab, and a third cross-sectional area at a third location along the length of the tab, wherein the second location is between the first location and the third location, and the second cross-sectional area is less than at least one of the first cross-sectional area or the third cross-sectional area.

2. The electrode of claim 1, wherein the tab comprises:
a first curvilinear edge positioned between the first location and the third location along a first side of the length of the tab, wherein the first curvilinear edge extends through the second location; and
a second curvilinear edge positioned between the first location and the third location along a second side of the length of the tab, wherein the second curvilinear edge extends through the second location.

3. The electrode of claim 2, wherein:
the first curvilinear edge forms a first semi-circle; and
the second curvilinear edge forms a second semi-circle.

4. The electrode of claim 1, comprising:
a first tapered edge positioned between the first location and the second location along a first side of the length of the tab; and
a second tapered edge positioned between the first location and the second location along a second side of the length of the tab, the second side opposing the first side.

5. The electrode of claim 1, wherein the first cross-sectional area is substantially equal to the third cross-sectional area.

6. The electrode of claim 1, wherein the first cross-sectional area is larger than the third cross-sectional area, the first location is at or adjacent to a proximal end of the tab, and the proximal end is coupled to the body.

7. The electrode of claim 1, wherein the tab comprises a reduced width or a reduced thickness at the second location relative to the first location and the third location.

8. An electrode assembly comprising:
an electrode comprising a body and a tab extending from the body, wherein the tab comprises a first tab cross-sectional area at a first tab location along a length of the tab, a second tab cross-sectional area at a second tab location along the length of the tab, and a third tab cross-sectional area at a third tab location along the length of the tab, wherein the second tab location is between the first tab location and the third tab location, and the second tab cross-sectional area is less than at least one of the first tab cross-sectional area or the third tab cross-sectional area;
an additional electrode comprising an additional body and an additional tab extending from the additional body, wherein the additional tab comprises a first additional tab cross-sectional area at a first additional tab location along an additional length of the additional tab, a second additional tab cross-sectional area at a second additional tab location along the additional length of the additional tab, and a third additional tab cross-sectional area at a third additional tab location along the additional length of the additional tab, wherein the second additional tab location is between the first additional tab location and the third additional tab location, and the second additional tab cross-sectional area is less than at least one of the first additional tab cross-sectional area or the third additional tab cross-sectional area; and
a plurality of electrodes disposed between the electrode and the additional electrode.

9. The electrode assembly of claim 8, comprising a plurality of anodes including the electrode, the additional electrode, and the plurality of electrodes.

10. The electrode assembly of claim 8, comprising a plurality of cathodes including the electrode, the additional electrode, and the plurality of electrodes.

11. The electrode assembly of claim 8, comprising an additional plurality of electrodes disposed between the electrode and the additional electrode, wherein the plurality of electrodes corresponds to a plurality of anodes, and the additional plurality of electrodes corresponds to a plurality of cathodes.

12. The electrode assembly of claim 8, wherein each electrode of the plurality of electrodes comprises a respective body and a respective tab, wherein the respective tab comprises a respective proximal end coupled to the respective body, a respective distal end opposing the respective proximal end, a first respective substantially straight edge extending from the respective proximal end to the respective distal end, and a second respective substantially straight edge extending from the respective proximal end to the respective distal end, the second respective substantially straight edge opposing the first substantially respective straight edge across a respective width of the respective tab.

13. The electrode assembly of claim 8, wherein:
a sizing of the second tab cross-sectional area relative to the first tab cross-sectional area and the third tab cross-sectional area is configured to promote a controlled bending of the tab at the second tab location during assembly of a battery comprising the electrode assembly; and
an additional sizing of the second additional tab cross-sectional area relative to the first additional tab cross-sectional area and the third additional tab cross-sectional area is configured to promote an additional controlled bending of the additional tab at the second additional tab location during assembly of the battery.

14. An electrode assembly comprising:
a first electrode comprising a first body and a first tab extending from the first body, wherein the first tab comprises a first cross-sectional area at a first location along a length of the first tab, a second cross-sectional area at a second location along the length of the first tab, and a third cross-sectional area at a third location along the length of the first tab, wherein the second location is between the first location and the third location, and the second cross-sectional area is less than at least one of the first cross-sectional area or the third cross-sectional area; and
a second electrode comprising a second body and a second tab, wherein the second tab comprises a proximal end coupled to the second body, a distal end opposing the proximal end, a first substantially straight edge extending from the proximal end to the distal end, and a second substantially straight edge extending from the proximal end to the distal end, the second substantially straight edge opposing the first substantially straight edge across a width of the second tab.

15. The electrode assembly of claim 14, wherein the first electrode comprises a first anode and the second electrode comprises a second anode.

16. The electrode assembly of claim 14, comprising a plurality of electrodes including the first electrode and the second electrode, wherein the plurality of electrodes is arranged in a stack, the first electrode is disposed at an end of the stack, and the second electrode is disposed in a mid-section of the stack.

17. The electrode assembly of claim 16, wherein the plurality of electrodes comprises a third electrode having a third body and a third tab extending from the third body, wherein the third tab is substantially equal in shape to the first tab, and the third electrode is disposed at an additional end of the stack opposing the end of the stack.

18. The electrode assembly of claim 14, wherein the first tab comprises a reduced width or a reduced thickness at the second location relative to the first location and the third location.

19. The electrode assembly of claim 14, wherein the first cross-sectional area is substantially equal to the third cross-sectional area.

20. The electrode assembly of claim 14, wherein the first cross-sectional area is larger than the third cross-sectional area, the first location is at or adjacent to an additional proximal end of the first tab, and the additional proximal end is coupled to the first body.

21. An electrode, comprising:
a body; and
a tab extending from the body, wherein the tab comprises a first stiffness at a first location along a length of the tab based on a first tab characteristic at the first location, a second stiffness at a second location along the length of the tab based on a second tab characteristic at the second location, and a third stiffness at a third location along the length of the tab based on a third tab characteristic at the third location, wherein the second location is between the first location and the third location, and the second stiffness is different than at least one of the first stiffness or the third stiffness based on the second tab characteristic differing from at least one of the first tab characteristic or the third tab characteristic.

22. The electrode of claim 21, wherein:
the first tab characteristic comprises a first cross-sectional area of the tab at the first location;
the second tab characteristic comprises a second cross-sectional area of the tab at the second location; and
the third tab characteristic comprises a third cross-sectional area of the tab at the third location.

23. The electrode of claim 21, wherein:
the first tab characteristic comprises a first width of the tab or a first thickness of the tab at the first location;
the second tab characteristic comprises a second width of the tab or a second thickness of the tab at the second location; and
the third tab characteristic comprises a third width of the tab or a third thickness of the tab at the third location.

24. The electrode of claim 21, wherein:
the first tab characteristic comprises a first porosity of the tab or a first density of the tab at the first location;
the second tab characteristic comprises a second porosity of the tab or a second density of the tab at the second location; and
the third tab characteristic comprises a third porosity of the tab or a third density of the tab at the third location.

25. The electrode of claim 21, wherein:
the first tab characteristic comprises a lack of perforations in the tab at the first location;
the second tab characteristic comprises perforations in the tab at the second location; and
the third tab characteristic comprises an additional lack of perforations in the tab at the third location.

26. The electrode of claim 21, wherein the second stiffness is less than the first stiffness and the third stiffness.

27. The electrode of claim 21, wherein the second stiffness is greater than the first stiffness and the third stiffness.
